(19) United States
(12) Patent Application Publication
(10) Pub. No.: US 2024/0327296 A1
(43) Pub. Date: Oct. 3, 2024

(54) ROTATING SEAL RING MATERIAL

(71) Applicant: John Crane Inc., Morton Grove, IL (US)

(72) Inventors: Sunilkumar C. Pillai, Buffalo Grove, IL (US); Ragini Thurpati, Bartlett, IL (US); Klaus-Dieter MECK, Manchester (GB)

(21) Appl. No.: 18/579,832

(22) PCT Filed: Jul. 18, 2022
(86) PCT No.: PCT/IB2022/056595

§ 371 Date: Jan. 16, 2024

Related U.S. Application Data
(60) Provisional application No. 63/222,464, filed on Jul. 16, 2021.

(51) Int. Cl. C04B 35/565; C04B 35/626; C04B 35/645

(52) U.S. Cl. CPC C04B 35/565; C04B 35/6261; C04B 35/6264; C04B 35/62655; C04B 35/62675; C04B 35/645; C04B 2235/383; C04B 2235/3865; C04B 2235/5436; C04B 2235/5445; C04B 2235/5454; C04B 2235/786; C04B 2235/9607

(57) ABSTRACT

The present invention relates to an unsintered composite powder composition comprising silicon carbide and aluminium nitride, a sintering process and a sintered silicon carbide material obtained or obtainable therefrom, as well as a SiC—AlN composite ceramic, uses thereof and articles comprising the same. In one aspect, the present invention provides an unsintered composite powder composition comprising from 90.0% to 99.9% by weight silicon carbide and from 0.1% to 10% by weight of aluminium nitride. In another aspect, the present invention provides a SiC—AlN composite ceramic material having the formula ₓ(SiC)—₁₋ₓ (AlN), wherein 0.999≥x≥0.900; and wherein the composite ceramic material has a fracture toughness of greater than 4.5 MPa·m^{1/2}; and a thermal conductivity of greater than 120 W/m K.

### BACKGROUND

Exemplary embodiments pertain to the art of rotating seals and, in particular, to seal rings used in rotating seals. In particular, the present invention relates to an unsintered composite powder composition comprising silicon carbide and aluminium nitride, a sintering process and a sintered silicon carbide material obtained or obtainable therefrom, as well as a SiC—AlN composite ceramic, uses thereof and articles comprising the same.

There are several types of seals that can be used to provide a seal between a rotating shaft and a stationary housing of a pump, compressor, turbine, or other rotating machine. One example is an end face mechanical seal. Such seals include a seal interface formed of two rings that each have a face and that are arranged such that the two faces slidingly contact one another.

In operation one of the rings rotates with the rotating shaft and the other is held in a fixed position. The rotating ring is sometimes referred to as a “mating ring” as it is mated to the rotating shaft/rotor. The rotating ring can be mated to the rotor via a shaft sleeve. The stationary ring can sometimes be referred to as the primary ring and does not rotate during operation.

Frictional wear between the seal faces of the rings can cause a gap to form between the two faces leading to excessive leakage. Accordingly, such seals require regular adjustment in order to maintain the appropriate or axial position of the faces relative to one another to account for the wear while still maintaining a relatively leak-free seal. Of course, some leakage can occur regardless of how well the faces are manipulated.

Various biasing mechanisms have been contemplated to provide a closing force to automatically accommodate wear and push the seal faces together. Such biasing mechanism have included single and multiple coil springs, and metal bellows. The skilled artisan will realize that the total closing force is actually a combination of hydraulic force from the sealed fluid and force provided by the biasing mechanism.

Silicon carbide is a non-oxide ceramic material having excellent thermo-mechanical properties, such as high strength, high thermal conductivity, high hardness, high stiffness and excellent wear resistance. It also has good chemical resistance. Hence, this material is widely used in tribological applications, especially as mechanical seal face components.

Silicon carbide-based ceramic seals are commercially available in various forms such as reaction-bonded silicon carbide, solid-state sintered silicon carbide (SS SiC) and liquid-phase sintered silicon carbide (LP SiC).

### SUMMARY OF THE INVENTION

The inventors have discovered that materials used in current ceramic seals have certain drawbacks that limit their use in certain applications. For example, self-sintered SiC has a reasonable strength (of about 450 Mpa) but its lower fracture toughness (˜4 Mpa·m^{1/2}) limits its use under high PV conditions. Likewise, liquid-phase sintered SiC has higher strength (around 650 Mpa) and higher fracture toughness (around 6 MPa·m^{1/2}, as measured by the single edge notch bending (SENB) method, for instance, in accordance with ASTM D5045), but the thermal conductivity (˜90 W/m-K) and contact wear resistance are lower.

In order to overcome these limitations, the current document discloses details of an improved silicon carbide composition having higher strength, higher fracture toughness along with higher thermal conductivity and higher contact wear resistance than known silicon carbide compositions, and the process to make it.

In one aspect, the present invention provides an unsintered composite powder composition comprising from 90.0% to 99.9% by weight silicon carbide and from 0.1% to 10% by weight of aluminium nitride.

In another aspect, the present invention provides a SiC—AlN composite ceramic material obtained or obtainable by sintering the unsintered composite powder composition as described herein.

In yet another aspect, the present invention provides a SiC—AlN composite ceramic material having the formula ₓ(SiC)—₁₋ₓ(AlN), wherein 0.999≥x≥0.900; and wherein the composite ceramic material has a fracture toughness of greater than 4.5 MPa·m^{1/2}; and a thermal conductivity of greater than 120 W/m K.

In a further aspect, the present invention provides a process for manufacturing an unsintered composite powder as described herein, wherein the process comprises combining a silicon carbide powder and an aluminium nitride powder in an amount of from 90.0% to 99.9% by weight silicon carbide and from 0.1% to 10% by weight of aluminium nitride so as to form the unsintered composite powder composition.

In yet a further aspect, the present invention provides an article comprising a component formed of a SiC—AlN composite ceramic material as described herein.

In still another aspect, the present invention relates to a mechanical seal face formed of SiC—AlN composite ceramic material as described herein.

In yet another aspect, the present disclosure relates to the use of a SiC—AlN composite ceramic material as described herein in a mechanical seal, a bearing or a wear part.

Some of the major application areas (not limited to) for these materials are: mechanical seal faces, bearings, wear parts (for both dry and wet applications), etc.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings, in which:

FIG. 1 shows a flow chart of the process by which the SiC—AlN composite ceramic material may be prepared;

FIG. 2 shows steady state coefficient of friction (CoF) test result for materials of the examples in air at 60% humidity;

FIG. 3 shows a comparison of Coefficient of Wear (CoW) test results for materials of the examples in air at 60% humidity; and

FIG. 4 shows Coefficient of Wear (CoW) test results determined using the ball-on-disc (BoD) method under dry condition under nitrogen (at a due point of −40° C.) for materials of the examples.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

In one aspect, the present invention provides an unsintered composite powder composition comprising from 90.0% to 99.9% by weight silicon carbide and from 0.1% to 10% by weight of aluminium nitride. The unsintered composition of the invention has been found to be particularly useful as a precursor to a SiC—AlN composite ceramic material which has been found to be advantageous in applications requiring, in particular, both high fracture toughness as well as high thermal conductivity. The combination of both high fracture toughness and high thermal conductivity has not hitherto been realized in conventional SiC ceramics or AlN ceramics.

The SiC—AlN composite ceramic material which may be formed from the unsintered composite powder composition described herein has been found to be particularly useful in forming seals in turbomachinery applications. For example, the outboard seal of a two-seal system of a centrifugal gas compressor typically operates at low pressure but high speed. Materials subjected to such conditions should have high tensile strength to withstand hoop stress due to high shaft rotational speeds and high thermal conductivity combined with low coefficient of thermal expansion to minimize the thermal coning or tapering of the sealing interface, which compromises the ability of the seal face grooves to generate a stabile fluid film. The inboard seal in such systems operates at high-pressure, sealing the process gas at high speed. Materials subjected to such conditions should have high mechanical strength to minimize the component distortion from pressure and abutment loading and high thermal conductivity combined with low coefficient of thermal expansion to minimize thermal distortion of the seal components too. As with the outboard seal, a “form stabile” sealing interface gap is important for the fluid film stability but equally to limit the leakage across the sealing gap.

The inventors have found from the performance simulation of the outboard seal of a turbo gas seal that conventional gas seal ceramics (SiC and Si₃N₄) suffer from excessive thermal interface taper at high speed which limits the maximum speed rating for these materials, even before the component stress levels may become critically high. The reason for this is that, due to increasing viscous sheer at the sealing interface with speed, high thermal gradients within the component cause “thermal coning” or increasing thermal sealing interface taper, which cases the interface gas seal grooves to generate less hydrodynamic lift. This would consequently result in a “collapse” of the fluid film gap at high speed and catastrophic failure of the entire gas seal.

The SiC—AlN composite ceramic material, preparable from the unsintered powder composite compositions described herein may reduce or minimize the changes of sealing interface flatness with speed suffered by seals formed from conventional materials. The fluid film gap can be maintained up to the maximum speed and hoop stress the material can withstand. As an example, while a conventional SiC material may be limited to 140 m/s rotational velocity because of thermal coning, the SiC—AlN composite ceramic material with similar mechanical strength can reach speeds in excess of 250 m/s.

The presence of aluminium nitride in the unsintered composite powder composition is in an amount of from 0.1 to 10 wt. % has been found to be key feature in forming a ceramic material with particularly advantageous properties, which is believed to be a result of modifications to the microstructure of the resulting ceramic that are not exhibited in pure silicon carbide ceramics, or pure aluminium nitride ceramics. In a preferred embodiment, the unsintered composite powder composition, comprises from 95.0% to 99.9% by weight silicon carbide and from 0.1% to 5.0% by weight aluminium nitride. More preferably, the unsintered composite powder composition, comprises from 95.0% to 99.9% by weight silicon carbide and from 0.1% to 5.0% by weight aluminium nitride.

The present invention also provides a process for manufacturing an unsintered composite powder composition, as well as a SiC—AlN composite ceramic as described herein.

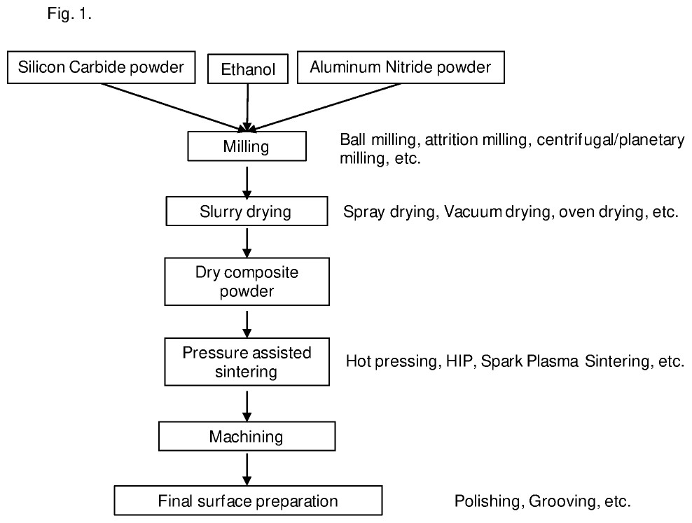

Conventional solid state synthesis methods for making ceramic materials, typically involve milling of starting powders followed by shaping, and optionally calcining, before sintering to produce the desired ceramic product. Milling can be either wet or dry type milling. High energy vibratory milling may be used, for instance, to mix starting powders, as well as for post-calcination grinding, if utilized. Where wet milling is employed, the powders are mixed with a suitable liquid (e.g., ethanol or water, or combinations thereof) to form a slurry and wet milled with a suitable high density milling media (e.g., yttria stabilized zirconia (YSZ) beads, or even silicon carbide balls). Before being sintered to produce a ceramic product with preferably high sintered density, the milled powders may be optionally calcined, and/or optionally formed into a desired shape (e.g., pellets). Once the composite ceramic material has been prepared following sintering, post-sintering machining processes and surface preparation may also be undertaken, as desired. Reference is also made to FIG. 1 which depicts a flow chart of the process by which the SiC—AlN composite ceramic material may be prepared.

Thus, as will be appreciated, the unsintered composite powder composition described herein is obtainable, for instance, from the milling and other process steps undertaken prior to sintering to form a composite ceramic. The unsintered composite powder composition described herein may thus comprise additional components relating to the subsequent process for forming a composite ceramic material. For instance, the unsintered composite powder composition may comprise stabilisers, binders and/or sintering aids, although these are preferably kept to a minimum or excluded entirely. Common sintering aids, for instance, include Y₂O₃, CaO, SiO₂, La₂O₃, CeO₂, SiO₂, Al₂O₃, and TiO₂.

Thus, in some embodiments the unsintered composite powder composition comprises less than 5% by weight of additional components such as sintering aids, preferably less than 3% by weight, less than 2% by weight, less than 1%, or even less than 0.1% by weight or even less than 0.01% by weight of additional components such as sintering aids. In particularly preferred embodiments, the unsintered composite powder composition consists, or consists essentially, of silicon carbide and aluminium nitride.

As the skilled person will appreciate, high purity silicon carbide and aluminum nitride starting powders are commercially available and at varying particle size specifications. Alpha-silicon carbide (α-SiC) is the most common crystalline form (polymorphic form) of silicon carbide and has a hexagonal crystal structure, although other polymorphic forms (e.g. beta-silicon carbide (β-SiC)) are known. In some embodiments, the silicon carbide material that may be used in connection with the present invention comprises or consists of alpha-silicon carbide (α-SiC).

Silicon carbide powders of varying average particle size (D₅₀) may be used in forming the unsintered composite powder composition of the invention. In some embodiments, the silicon carbide component in the unsintered composite powder composition has an average particle size of 0.1 μm to 5 μm, preferably less than or equal to 3 μm, such as from 0.2 μm to 2 μm, or more preferably 0.2 μm to 1 μm. Particle size of the silicon carbide component may be determined, for instance, using known light scattering techniques and instruments employing the same (such as the Zetasizer 1000HS of M/s Malvern Instruments Ltd, UK).

Aluminium nitride powders of varying average particle size (D₅₀) may be used in forming the unsintered composite powder composition of the invention, although it is preferred that the aluminium nitride powder component has a smaller average particle size than the silicon carbide powder component. In preferred embodiments, the aluminium nitride component in the unsintered composite powder composition comprises aluminium nitride nanoparticles (e.g. aluminium nitride particles having an average particle size (D₅₀) of 1.0 nm to 1,000 nm). Preferably, the average particle size (D₅₀) of the aluminium nitride in the unsintered composite powder composition is from 10 nm to 500 nm. Particle size of the aluminium nitride component may be determined, for instance, using known transmission electron microscopy (TEM) techniques.

The unsintered composite powder composition described herein may be obtained by admixing silicon carbide and aluminium nitride starting powders, including any of those described herein, and milling (and optionally drying) to form the unsintered composite powder composition. As mentioned above, as part of preparing a ceramic composite material, it is typical for an admixture of starting powders to undergo dry milling or preferably wet milling (i.e. as part of a slurry in a liquid medium). Thus, the powders of silicon carbide and aluminium nitride described above may be admixed in a chosen weight ratio (which may be selected to ultimately yield a SiC—AlN composite ceramic material having the desired molar ratio of components) and contacted with a suitable liquid medium (as shown in the first stage in the flow chart of FIG. 1) in order to provide a slurry which may then be wet milled. Suitable liquid media for this purpose are those in which silicon carbide and aluminium nitride are insoluble and/or non-reactive, and include liquid media selected from a C1 to C5 aliphatic monohydric alcohol, such as methanol, ethanol, iso-propanol, n-butanol or n-heptanol, water or combinations thereof. Preferably, where a slurry is formed for wet milling, a liquid medium comprising or consisting of ethanol is used, as shown in FIG. 1. In preferred embodiments, a slurry is formed from a silicon carbide powder with an average particle size of less than or equal to 3 μm, such as from 0.2 μm to 3 μm and/or a slurry is formed from an aluminium nitride nanoparticle powder with an average particle size of from 10 nm to 500 nm.

The particular form of milling is not particularly limited and examples of suitable milling techniques include roller milling, ball milling, attrition milling, and centrifugal/planetary milling. In some embodiments, ball milling is used, optionally where the milling media comprises YSZ beads, silicon nitride balls or silicon carbide balls. Use of silicon carbide balls as the milling media may be advantageous in avoiding contamination or leaching of unwanted components from alternative milling media in order to maximise the purity of the resulting milled product prior to sintering. Such contamination of leaching from the milling media is not an issue where the milling media itself is formed from silicon carbide. The skilled person is able to select a particular form of milling, for example roller milling, based on the form of milling (i.e. dry or wet), intended particle size of the components of the resulting milled product, and the timescale over which milling may take place (e.g. 15 to 25 hours), Typical milling timescales will depend on the scale of the production but typically range from 6 to 48 hours, preferably 12 to 36 hours, more preferably from 15 to 25 hours, for example 18 to 20 hours.

As shown in flow chart of FIG. 1, where a wet milling step has been used, the next step in the process is typically a drying step, which may be utilized to produce the unsintered composite powder composition. The particular form of drying is not particularly limited, and drying under a vacuum, oven drying or spray drying may be utilised. In some embodiments, the slurry is dried under a vacuum at a temperature of from 80° C. to 100° C. In some embodiments, the slurry is spray dried at a temperature of from 100° C. to 140° C. An example of suitable lab-scale spray dryer includes the mini B-290 spray drier from Buchi or the L-8i spray dryer from Ohkawara Kakohki, depending on scale.

As shown in the flow chart of FIG. 1, following any drying step, the unsintered composite powder composition may undergo screening/sieving to obtain a powder composite of desired particle size distribution. In some embodiments, after milling, and drying if carried out, the unsintered composite powder is passed through a screen with a pore size of from 250 μm to 350 μm, for example a screen with pore size of from 275 μm to 325 μm, for example 300 μm,

In accordance with another aspect, the present invention provides a SiC—AlN composite ceramic material obtained or obtainable by sintering an unsintered composite powder composition as described herein. The sintering step may be pressure assisted, as indicated in the flow chart of FIG. 1, and may for example comprise hot pressing, spark plasma sintering, hot isostatic pressing (HIP), gas pressure sintering, or any combination thereof.

There is no particular limitation on the temperature of the sintering step, since lower temperatures may be appropriate under certain pressure assisted conditions provided adequate sintering is achieved, which may be readily determined by microstructural analysis of the product. For example, scanning electron microscope (SEM) analysis or transmission electron microscope (TEM) analysis which may be used to quantify grain sizes and distribution and assess grain boundaries. Density and porosity of the product can also be readily determined by known methods, such as ASTM C373-88. Suitable sintering temperatures are typically those at or above 1800° C., for example, and suitable pressures adopted in pressure assisted sintering systems are at least 5 MPa.

In some embodiments, the SiC—AlN composite ceramic material is obtained or obtainable from sintering of the unsintered composite powder composition at a temperature of from 1800° C. to 2100° C. preferably from 1800° C. to 2000° C., more preferably from 1850° C. to 1950° C. Where pressure assisted sintering is adopted, a suitable range of pressures over which sintering occurs is from 5 MPa to 75 MPa, preferably from 10 MPa to 60 MPa, more preferably from 30 MPa to 50 MPa.

In some embodiments, the SiC—AlN composite ceramic material obtained or obtainable from sintering of the unsintered composite powder composition as described herein comprises sintered alpha-silicon carbide. In some embodiments, the SiC—AlN composite ceramic material obtained or obtainable from sintering of the unsintered composite powder composition as described herein comprises sintered silicon carbide having a grain size of from 2.0 to 3.0 μm.

Following sintering, the SiC—AlN composite ceramic material obtained, may be subject to machining (i.e. shaping for different applications) or final surface preparation (such as polishing or grooving, etc), as shown in FIG. 1.

The SiC—AlN composite ceramic material obtained or obtainable from sintering of the unsintered composite powder composition as described herein has been found to exhibit several advantageous properties in combination, that make it particularly suitable for seal applications subject to high speed, high thermal gradients and high hoop stresses, such as in turbomachinery applications (for example in the inbound or outboard seal of a two-seal system of a centrifugal gas compressor). Such advantageous properties include low coefficient of thermal expansion together with high thermal conductivity (in order to minimize the thermal coning or tapering of a sealing interface, for instance), as well as high mechanical strength (in order to minimize the component distortion from pressure and abutment loading).

A combination of features that has been found to be particularly surprising in the SiC—AlN composite ceramic material obtained or obtainable from sintereing and unsintered composite powder composition as described herein is the combination of high fracture toughness (e.g. of greater than 4.5 MPa·m^{1/2}) and high thermal conductivity (e.g. of greater than 120 W/m K), This particular combination of features has not hitherto been seen in SiC ceramics or silicon nitride (Si₃N₄) ceramics, for instance, which are conventional seal materials of choice. Fracture toughness may suitably be measured using ASTM C1421 (Chevron notch method) and thermal conductivity may suitably be measured using ASTM E1461.

The presence of AlN at the required concentration in the composite ceramic materials described herein is considered to be particularly advantageous in modifying the microstructure of the ceramic (in comparison, for instance, to conventional SiC ceramics). The substantial absence of components other than SiC and AlN in forming the ceramic composite is also considered to be of particular benefit in maximizing the favourable interaction of SiC and AlN in the resulting composite ceramic which obtainable from sintering of the unsintered composite powder composition described herein.

Thus, in yet another aspect, the present invention also provides a SiC—AlN composite ceramic material having the formula ₓ (SiC)—₁₋ₓ (AlN), wherein 0.999≥x≥0.900; and wherein the composite ceramic material has a fracture toughness of greater than 4.5 MPa·m^{1/2}; and a thermal conductivity of greater than 120 W/m K.

In a preferred embodiment, the SiC—AlN composite ceramic material has the formula ₓ (SiC)—₁₋ₓ (AlN), wherein 0.999≥x≥0.950;

In some embodiments, the SiC—AlN composite ceramic materials described herein have a fracture toughness of greater than or equal to 5 MPa·m^{1/2}, preferably from 5.0 to 6.0 MPa·m^{1/2}.

In some embodiments, the SiC—AlN composite ceramic materials described herein have a thermal conductivity of from 110 W/m K to 150 W/m K; preferably from 115 W/m K to 150 W/m K; more preferably from 120 W/m K to 145 W/m K.

In some embodiments, the SiC—AlN composite ceramic materials described herein have a coefficient of thermal expansion of the sintered silicon carbide material is less than 4×10⁻⁶/K. The coefficient of thermal expansion may suitably be measured using ASTM E228.

In some embodiments, the SiC—AlN composite ceramic materials described herein have a flexural strength of more than or equal to 600 MPa; preferably from 600 MPa to 850 MPa; and more preferably from 700 MPa to 850 MPa. Flexural strength may suitably be measured using ASTM C1161 (4-point).

In some embodiments, the SiC—AlN composite ceramic materials described herein have an elastic modulus of from 400 GPa to 450 GPa; preferably from 420 GPa to 450 GPa. Elastic modulus may suitably be measured using ASTM E494.

In some embodiments, the SiC—AlN composite ceramic materials described herein have one or more of the following properties:
(a) a density of from 3.0 to 3.3 g/cm³;
(b) a porosity of less than 5%; preferably less than 2.5%; more preferably less than 1%; and
(c) a Poisson's ratio of from 0.10 to 0.20; preferably from 0.14 to 0.18.

Density and porosity may suitably be measured using ASTM C373-88, whilst Poisson's ratio may suitably be measured using ASTM E494.

In some embodiments, the SiC—AlN composite ceramic materials described herein have a coefficient of friction of less than 0.5, in gaseous fluids (air, nitrogen, carbon dioxide, etc.) with a relative humidity of less than 60%; preferably less than 0.4; and most preferably less than 0.3.

In some embodiments, the SiC—AlN composite ceramic materials described herein have a a coefficient of wear of less than 0.00001 mm³/Nm, in gaseous fluids (for example, air, nitrogen, carbon dioxide, etc.) having a relative humidity of less than 60%; preferably less than 0.000005 mm³/Nm; and/or a coefficient of wear under dry conditions of less than 0.0001 mm³/Nm; preferably less than 0.000005 mm³/Nm.

Coefficients of Friction and Wear may suitably be determined by the Ball-on-Disc method according to ASTM G-99, where a disc of a specific material is rotated at a fixed speed, and a ball of the mating material is moved into contact with the disc until contact is made and a known force is applied for a specific length of time. During the test, the normal and lateral loads are measured and the coefficient of friction can be determined from these two forces. After the test is completed, the volume of material removed from the disc and the ball is measured, following which the coefficient of wear may be determined.

In some embodiments, the SiC—AlN composite ceramic materials described herein have a tensile strength of greater than 300 MPa; preferably greater than 350 MPa; and more preferably from 375 MPa to 450 MPa.

In some embodiments, the process for preparing a SiC—AlN composite ceramic material described herein further comprises further processing the sintered silicon carbide material into an article of manufacture, or component thereof.

Therefore, in yet a further aspect, the present invention provides an article comprising a component formed of a SiC—AlN composite ceramic material as described herein. As discussed herein, the particular combination of properties exhibited by the SiC—AlN composite ceramic material make it useful for different applications, particularly those subjected to high speed, high thermal gradients and high hoop stresses, such as in turbomachinery applications (for example in the inbound or outboard seal of a two-seal system of a centrifugal gas compressor).

Thus, in still another aspect, the present invention provides a mechanical seal face formed of SiC—AlN composite ceramic material as described herein.

In yet another aspect, the present disclosure provides the use of a SiC—AlN composite ceramic material as described herein in a mechanical seal, a bearing or a wear part.

In another aspect, the present disclosure provides the use of a SiC—AlN composite ceramic material as described herein for improving tolerance to centrifugal stresses (e.g. hoop stresses) in a mechanical seal face component.

The detailed description of one or more embodiments of the disclosed apparatus and method are presented herein by way of exemplification and not limitation with reference to the Figures.

Various embodiments are described herein with reference to the related drawings. Alternative embodiments can be devised without departing from the scope of this disclosure.

Turning now to an overview of technologies that are more specifically relevant to aspects of the invention, a newly developed SiC—AlN composite ceramic material, “JC-SiC” having the following composition as shown below is disclosed:

Alpha-Silicon carbide (average grain size 0.7 micrometers)=95.0-99.9 wt % Aluminum nitride (nano-particles)-0.1-5.0 wt % In one embodiment, the material can be formed as described below:

Silicon carbide and aluminum nitride powders are added to ethanol (200 proof) in a plastic container. Silicon nitride balls are used as milling media. Slurry is milled for 18-20 hours using a roller mill and then dried at 90° C. under vacuum. The powder thus received is screened using a 300 micrometer screen. Powder is then consolidated using a combination of pressure (10-50 MPa) and temperature (1800-2100° C.). Consolidated parts are then machined to sizes followed by final surface finishing operations.

A flow chart of this process is shown in FIG. 1.

The proposed seals can address one or more of the problems identified below related seals. For example, in the outboard seal of a two-seal system typically operate at low pressure but high speed. Materials subjected to such conditions should have high tensile strength to withstand hoop stress due to high shaft rotational speeds and high thermal conductivity combined with low coefficient of thermal expansion to minimize the thermal coning or tapering of the sealing interface, which compromises the ability of the seal face grooves to generate a stabile fluid film. The inboard seal in such systems operate at high-pressure, sealing the process gas at high speed. Materials subjected to such conditions should have high mechanical strength to minimize the component distortion from pressure and abutment loading and high thermal conductivity combined with low coefficient of thermal expansion to minimize thermal distortion of the seal components too. As with the outboard seal, a “form stabile” sealing interface gap is important for the fluid film stability but equally to limit the leakage across the sealing gap.

From the performance simulation of the outboard seal of a turbo gas seal it is evident that conventional gas seal ceramics (SiC and Si₃N₄) suffer from excessive thermal interface taper at high speed which limits the maximum speed rating for these materials, even before the component stress levels may become critically high. The reason for this is that, due to increasing viscous sheer at the sealing interface with speed, high thermal gradients within the component cause “thermal coning” or increasing thermal sealing interface taper, which cases the interface gas seal grooves to generate less hydrodynamic lift. This would consequently result in a “collapse” of the fluid film gap at high speed and catastrophic failure of the entire gas seal.

The improved thermal properties of the JC-SiC material disclosed herein, however, may reduce or minimize the changes of sealing interface flatness with speed. The fluid film gap can be maintained up to the maximum speed and hoop stress the material can withstand. As an example, while a conventional SiC material maybe limited to 140 m/s rotational velocity because of thermal coning, the JC-SiC—S material with similar mechanical strength can reach speeds in the excess of 250 m/s.

The invention will now be further described by reference to the following examples, which are illustrative and not to be considered limiting.

### EXAMPLES

### Example 1: Preparation of Sintered Silicon Carbide Material (“JC-SiC”)

Silicon carbide and aluminum nitride powders are added to ethanol (200 proof) in a plastic container. Silicon nitride balls are used as milling media. Slurry is milled for 18-20 hours using a roller mill and then dried at 90° C. under vacuum. The powder thus received is screened using a 300 micrometer screen. Powder is then consolidated using a combination of pressure (10-50 MPa) and temperature (1800-2100° C.). Consolidated parts are then machined to sizes followed by final surface finishing operations. “JC-SiC—S” material was consolidated using a Spark Plasma Sintering (SPS) method whereas “JC-SiC—H” material was consolidated by Hot Pressing (HP).

### Example 2: Assessment of Properties of SiC—AlN Composite Ceramic Materials (“JC-SiC”) and Comparative Ceramics

Further, from the performance simulation of the inboard seal of a turbo gas seal it is evident that conventional gas seal ceramics (SiC and Si₃N₄) do not maintain the flatness of the sealing interface with increasing shaft velocity well. The reason is very similar to that of the outboard seal; viscous heating of the gas at the sealing interface and localised cooling form the expanding gas at the exit of the sealing gap causes temperature gradients that affect the flatness (coning). With increasing shaft velocity these factors are amplified. Changes to the face flatness effect the fluid film or gap stability, expressed by the film stiffness. Most significantly, the face flatness impacts the seal leakage (increasing). The improved thermal properties of the SiC—AlN composite ceramic (JC-SiC) material, however, limit the changes to the interface flatness with speed. The fluid film gap can be maintained up to the maximum speed (limited only by the outboard seal component stresses limit) without affecting film stability and leakage to greatly.

For further explanation, Table 1 is provided below. Table 1 shows the major thermo-mechanical properties of the JC-SiC materials (JC-SiC—S and JC-SiC—H) in comparison with solid-state sintered and liquid-phase sintered materials available commercially, measured in accordance with the ASTM methods recited hereinabove, unless otherwise indicated. It can be seen that the JC materials possess the best of both self-sintered (SS SiC) and Liquid-phase sintered (LP SiC) silicon carbide properties.

TABLE 1
Thermo-mechanical properties of JC materials in comparison
with SS sintered and LP sintered silicon carbide materials

| | | | | | Liquid- | |
|---|---|---|---|---|---|---|
| | | | | | phase | Self- |
| | Condi- | | JC- | JC- | sintered | sintered |
| Property | tion | Units | SiC—S | SiC—H | SiC | SiC |
| Density | | g/cm³ | 3.22 | 3.2 | >3.24 | 3.15 |
| Porosity | | % | <1 | <1 | <1 | — |
| Flexural | 20 C. | MPa | 748 | 680 | 650 | 400 |
| strength | | | | | | |
| (MOR) | | | | | | |
| Elastic | 20 C. | GPa | 453 | 420 | 430 | 430 |
| Modulus | | | | | | |
| Poisson's | 20 C. | | 0.16 | 0.18 | 0.17 | 0.17 |
| ratio | | | | | | |
| Fracture | Kic | MPa · | 5.0 | 5.8 | 6* | 4 |
| toughness | | m^{0.5} | | | | |
| Thermal | 20 C. | W/m K | 144 | 122 | 87 | 130 |
| conductivity | | | | | | |
| Coeff. | 25- | ×10⁻⁶/ | 4.0 | 4.1 | 4.1 | 4.4 |
| Thermal | 1000 C. | ° C. | | | | |
| Expansion | | | | | | |

*Based on the single edge notch bending (SENB) method, for instance, in accordance with ASTM D5045

### Example 3: Assessment of Tribological Properties

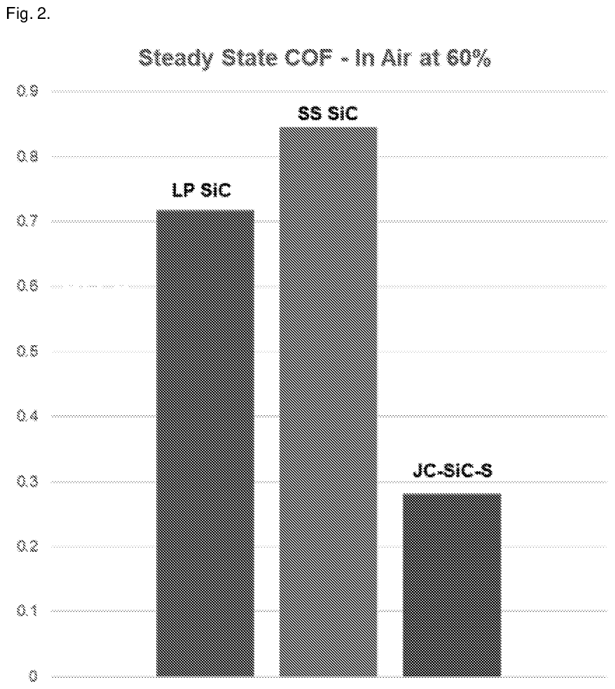

The Ball-on-Disc (BoD) test was used (for instance, in accordance with ASTM G-99) to evaluate tribological properties of the JC materials and the commercially available SS SiC and LP SiC materials. FIG. 2 shows the steady state coefficient of friction (CoF) of the above materials in air at 60% humidity. It can be seen that the CoF of JC SiC—S is about ⅓^{rd} of LP SiC and less than ½ of SS SiC.

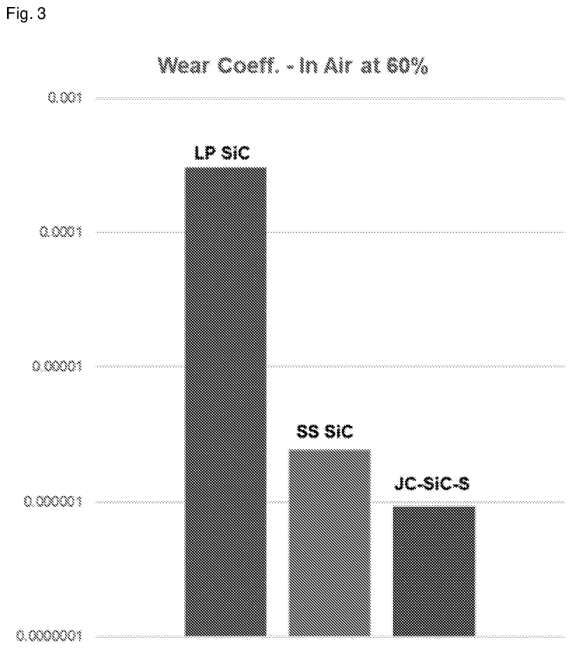

A comparison of Coefficient of Wear (CoW) in air at 60% humidity is shown in FIG. 3. Here, the CoW of JC-SiC—S is about 2½ orders lower than the LP SiC and significantly lower than the SS SiC.

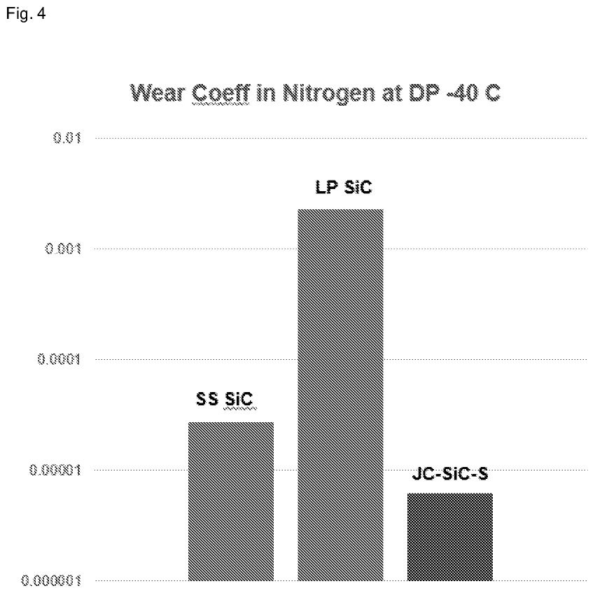

In order to evaluate the CoW under dry condition, BoD tests were carried out under nitrogen at due point −40 C. Results are shown in FIG. 4.

Again, it is clear that the CoW of JC-SiC—S is the lowest compared to the commercially available SiC materials.

Tribological evaluation clearly emphasizes the advantages of the SiC—AlN composite ceramic (JC-SiC) material in both dry and wet conditions over other commercially available materials used in these applications.

### Example 4: Assessment of Tensile Strength

Tensile strength was tested by spinning ring-shaped samples (OD=230 mm, ID=172, thickness=17 mm) in a high-speed test rig. Speed was increased in steps until the material failed. Based on the speed at failure, stress developed at that speed was calculated. Table 2 compares spin test results of JC-SiC—S with commercially available LP sintered SiC.

TABLE 2
Spin test results - Comparison

| Material | Speed at Failure | Calculated Stress at that Speed |
|---|---|---|
| JC-SiC-S | 22,000 rpm | 398 MPa |
| LP SiC | 21,000 rpm | 362 MPa |

Results show that JC-SiC—S is about 10% stronger than that of LP sintered SiC.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Also, the terms “coupled” and “connected” and variations thereof describes having a path between two elements and does not imply a direct connection between the elements with no intervening elements/connections between them. All of these variations are considered a part of the specification. However, any connections/couplings described can be a direct connections/couplings if that is specifically recited in the appended claims.

The connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

The invention claimed is:

1. An unsintered composite powder composition comprising from 90.0% to 99.9% by weight silicon carbide and from 0.1% to 10% by weight of aluminium nitride.

2. An unsintered composite powder composition according to claim 1, comprising from 95.0% to 99.9% by weight silicon carbide and from 0.1% to 5.0% by weight aluminium nitride.

3. An unsintered composite powder composition according to claim 1 or claim 2, wherein the composition comprises less than 5% by weight of additional components such as sintering aids.

4. An unsintered composite powder composition according to claim 1 or claim 2, wherein the composition comprises less than 3% by weight of additional components such as sintering aids.

5. An unsintered composite powder composition according to any preceding claim, wherein the composition consists essentially of silicon carbide and aluminium nitride.

6. An unsintered composite powder composition according to any preceding claim, wherein the composition consists of silicon carbide and aluminium nitride.

7. An unsintered composite powder composition according to any preceding claim, wherein the silicon carbide comprises alpha-silicon carbide.

8. An unsintered composite powder composition according to any preceding claim, wherein the aluminium nitride comprises aluminium nitride nanoparticles.

9. An unsintered composite powder composition according to any preceding claim, wherein the silicon carbide comprises particles with an average particle size of 0.1 μm to 5 μm.

10. An unsintered composite powder composition according to any preceding claim, wherein the aluminium nitride comprises particles with an average particle size of 1.0 nm to 1,000 nm.

11. An unsintered composite powder composition according to any preceding claim, wherein the composition is obtainable by milling a slurry of silicon carbide powder and aluminium nitride powder in a liquid medium.

12. An unsintered composite powder composition according to claim 11, wherein the slurry is formed from a silicon carbide powder with an average particle size of less than or equal to 3 μm, such as from 0.2 μm to 3 μm.

13. An unsintered composite powder composition according to claim 11 or claim 12, wherein the slurry is formed from an aluminium nitride nanoparticle powder with an average particle size of from 10 nm to 500 nm.

14. An unsintered composite powder composition according to any one of claims 11 to 13, wherein the slurry is formed from alpha-silicon carbide powder.

15. An unsintered composite powder composition according to any one of claims 11 to 14, wherein the liquid medium comprises a liquid in which the silicon carbide and aluminium nitride powders are insoluble and/or nonreactive.

16. An unsintered composite powder composition according to any one of claims 11 to 15, wherein the liquid medium comprises a C1 to C5 aliphatic monohydric alcohol, such as ethanol.

17. An unsintered composite powder composition according to any one of claims 11 to 16, wherein the milling is carried out for from 15 to 25 hours, optionally wherein the milling comprises the use of a roller mill.

18. An unsintered composite powder composition according to any one of claims 11 to 17, wherein the milling comprises milling the slurry with silicon nitride or silicon carbide balls as a milling media, with silicon nitride being preferred.

19. An unsintered composite powder composition according to any one of claims 11 to 18, wherein after milling, the slurry is dried to produce the unsintered composite powder; preferably wherein (i) the slurry is dried under vacuum, for example a temperature of from 80° C. to 100° C.; or (ii) the slurry is dried by spray drying at a temperature of from 80° C. to 140° C.

20. An unsintered composite powder composition according to any one of claims 11 to 19, wherein after milling, and drying if carried out, the unsintered composite powder is passed through a screen with a pore size of from 250 μm to 350 μm.

21. A SiC—AlN composite ceramic material obtainable by sintering an unsintered composite powder composition according to any preceding claim.

22. A SiC—AlN composite ceramic material according to claim 21, wherein the sintering comprises hot pressing, spark plasma sintering, hot isostatic pressing (HIP), gas pressure sintering or any combination thereof.

23. A SiC—AlN composite ceramic material according to claim 21 or claim 22, wherein the sintering comprises sintering at a temperature of above 1800° C.

24. A SiC—AlN composite ceramic material according to any one of claims 21 to 23, wherein the sintering comprises sintering at a temperature of 1800° C. to 2100° C.

25. A SiC—AlN composite ceramic material according to any one of claims 21 to 24, wherein the sintering comprises sintering at a pressure of from 5 MPa to 75 MPa.

26. A SiC—AlN composite ceramic material according to any one of claims 21 to 25, wherein the sintering comprises sintering at a pressure of from 10 MPa to 60 MPa.

27. A SiC—AlN composite ceramic material according to any one of claims 21 to 26, wherein SiC—AlN composite ceramic material comprises sintered alpha-silicon carbide.

28. A SiC—AlN composite ceramic material according to any one of claims 21 to 27, wherein the grain size of the sintered silicon carbide material is 2.0 to 3.0 μm.

29. A SiC—AlN composite ceramic material according to any one of claims 21 to 28, wherein the SiC—AlN composite ceramic material has a fracture toughness of greater than 4.5 MPa·m^{1/2}; and a thermal conductivity of greater than 120 W/mK.

30. A SiC—AlN composite ceramic material having the formula ₓ (SiC)—₁₋ₓ (AlN), wherein 0.999≥x≥0.900; and wherein the composite ceramic material has a fracture toughness of greater than 4.5 MPa·m^{1/2}; and a thermal conductivity of greater than 120 W/mK.

31. A SiC—AlN composite ceramic material according to claim 30, wherein the SiC—AlN composite ceramic material has the formula ₓ (SiC)—₁₋ₓ (AlN), wherein 0.999≥x≥0.950.

32. A SiC—AlN composite ceramic material according to any one of claims 21 to 31, wherein the sintered silicon carbide material has a fracture toughness of greater than or equal to 5 MPa·m^{1/2}.

33. A SiC—AlN composite ceramic material according to any one of claims 21 to 32, wherein the sintered silicon carbide material has a fracture toughness of from 5.0 to 6.0 MPa·m^{1/2}.

34. A SiC—AlN composite ceramic material according to any one of claims 21 to 33, wherein the sintered silicon carbide material has a thermal conductivity of from 110 W/mK to 150 W/mK; preferably from 115 W/mK to 150 W/mK; more preferably from 120 W/mK to 145 W/mK.

35. A SiC—AlN composite ceramic material according to any one of claims 21 to 34, wherein the coefficient of thermal expansion of the sintered silicon carbide material is less than 4×10⁻⁶/K.

36. A SiC—AlN composite ceramic material according to any one of claims 21 to 35, wherein the sintered silicon carbide material has a flexural strength of more than or equal to 600 MPa; preferably from 600 Mpa to 850 Mpa; and more preferably from 700 Mpa to 850 Mpa.

37. A SiC—AlN composite ceramic material according to any one of claims 21 to 36, wherein the sintered silicon carbide material has an elastic modulus of from 400 Gpa to 450 Gpa; preferably from 420 Gpa to 450 Gpa.

38. A SiC—AlN composite ceramic material according to any one of claims 21 to 37, wherein the sintered silicon carbide material has one or more of the following properties:
(a) a density of from 3.0 to 3.3 g/cm³;
(b) a porosity of less than 5%; preferably less than 2.5%; more preferably less than 1%; and
(c) a Poisson's ratio of from 0.10 to 0.20; preferably from 0.14 to 0.18.

39. A SiC—AlN composite ceramic material according to any one of claims 21 to 38, wherein the sintered silicon carbide material has a coefficient of friction, in gaseous fluids (air, nitrogen, carbon dioxide, etc.) with a relative humidity of less than 60%, of less than 0.5; preferably less than 0.4; and most preferably less than 0.3.

40. A SiC—AlN composite ceramic material according to any one of claims 21 to 39, wherein the sintered silicon carbide material has a coefficient of wear, in gaseous fluids (air, nitrogen, carbon dioxide, etc.) with a relative humidity of less than 60%, less than 0.00001 mm³/Nm; preferably less than 0.000005 mm³/Nm; and/or a coefficient of wear under dry conditions of less than 0.0001 mm³/Nm; preferably less than 0.000005 mm³/Nm.

41. A SiC—AlN composite ceramic material according to any one of claims 21 to 40, wherein the sintered silicon carbide material has a tensile strength of greater than 300 MPa; preferably greater than 350 MPa; and more preferably from 375 MPa to 450 MPa.

42. A process for manufacturing an unsintered composite powder composition according to any one of claims 1 to 20, wherein the process comprises combining a silicon carbide powder and an aluminium nitride powder in an amount of from 90.0% to 99.9% by weight silicon carbide and from 0.1% to 10% by weight of aluminium nitride so as to form the unsintered composite powder composition.

43. A process according to claim 42, wherein the silicon carbide powder and aluminium nitride powder are combined in an amount of from 95.0% to 99.9% by weight silicon carbide and from 0.1% to 5% by weight of aluminium nitride.

44. A process according to claim 42 or claim 43, wherein the unsintered composite powder composition comprises less than 5% by weight of additional components such as sintering aids.

45. A process according to any one of claims 42 to 44, wherein the composition comprises less than 2% by weight of additional components such as sintering aids.

46. A process according to any one of claims 42 to 45, wherein the composition consists essentially of silicon carbide and aluminium nitride.

47. A process according to any one of claims 42 to 46, wherein the composition consists of silicon carbide and aluminium nitride.

48. A process according to any one of claims 42 to 47, wherein the silicon carbide powder comprises alpha-silicon carbide.

49. A process according to any one of claims 42 to 48, wherein the aluminium nitride powder comprises aluminium nitride nanoparticles.

50. A process according to any one of claims 42 to 49, wherein the silicon carbide powder comprises particles with an average particle size of less than or equal to 3 μm, preferably from 0.2 μm to 3 μm.

51. A process according to any one of claims 42 to 50, wherein the aluminium nitride powder comprises particles with an average particle size of 10 nm to 500 nm.

52. A process according to any one of claims 42 to 51, wherein combining the silicon carbide powder and aluminium nitride powder comprises forming a slurry of the powders in a liquid medium.

53. A process according to claim 52, wherein the liquid medium comprises a C1 to C5 aliphatic monohydric alcohol, such as ethanol.

54. A process according to claim 52 or claim 53, wherein the process further comprises milling the slurry, optionally wherein milling the slurry comprises the use of a roller mill.

55. A process according to claim 54, wherein milling the slurry comprises milling the slurry with silicon carbide balls as a milling media.

56. A process according to any one of claims 52 to 55, further comprising drying the slurry.

57. A process according to claim 56, wherein the slurry is dried in a vacuum, and/or wherein the slurry is dried at a temperature of from 80° C. to 140° C.

58. A process according to claim 56 or claim 57, wherein drying the slurry comprises spray drying, vacuum drying or oven drying the slurry, or a combination thereof.

59. A process according to any one of claims 42 to 57, wherein, after formation, the unsintered composite powder composition is passed through a screen with a pore size of from 250 μm to 350 μm, wherein the composition is passed through the screen after the steps of milling and drying if said process steps are carried out.

60. A process for manufacturing a SiC—AlN composite ceramic material according to any one of claims 21 to 41, wherein the process comprises sintering an unsintered composite powder composition according to any one of claims 1 to 20.

61. A process according to claim 60, wherein sintering the unsintered composite powder composition comprises hot pressing, spark plasma sintering, hot isostatic pressing (HIP), gas pressure sintering or any combination thereof.

62. A process according to claim 60 or claim 61, wherein the sintering comprises sintering at a temperature of above 1800° C.

63. A process according to any one of claims 60 to 62, wherein the sintering comprises sintering at a temperature of 1800° C. to 2100° C.

64. A process according to any one of claims 60 to 63, wherein the sintering comprises sintering at a pressure of from 5 MPa to 75 MPa.

65. A process according to any one of claims 60 to 64, wherein the sintering comprises sintering at a pressure of from 10 MPa to 60 MPa.

66. A process according to any one of claims 60 to 65, wherein the process further comprises further processing the SiC—AlN composite ceramic material into an article of manufacture, or component thereof.

67. A process according to any one of claims 60 to 65, wherein the unsintered composite powder is manufactured by a process according to any one of claims 42 to 59.

68. An article comprising a component formed of a SiC—AlN composite ceramic material according to any one of claims 21 to 41.

69. An article according to claim 68, wherein the article is a mechanical seal, a bearing, or a wear part.

70. An article according to claim 68 or claim 69, wherein the article is a mechanical seal, and wherein the component is a mechanical seal face.

71. A mechanical seal face formed of a sintered silicon carbide material according to any one of claims 21 to 41.

72. The use of a SiC—AlN composite ceramic material according to any one of claims 21 to 39 in a mechanical seal, a bearing or a wear part; preferably wherein the sintered silicon carbide material is used in the face of a mechanical seal.

73. The use of a SiC—AlN composite ceramic material according to any one of claims 21 to 41 for improving tolerance to centrifugal stresses (e.g. hoop stresses) in a mechanical seal face component.
